(19) United States
(12) Patent Application Publication
(10) Pub. No.: US 2025/0062531 A1
(43) Pub. Date: Feb. 20, 2025

(54) ANTENNA DEVICE, ANTENNA MODULE, AND RADIO DEVICE

(71) Applicant: Sony Group Corporation, Tokyo (JP)

(72) Inventor: Kyosuke KUSUNOSE, Tokyo (JP)

(73) Assignee: Sony Group Corporation, Tokyo (JP)

(21) Appl. No.: 18/726,128

(22) PCT Filed: Dec. 19, 2022
(86) PCT No.: PCT/JP2022/046578

§ 371 Date: Jul. 2, 2024

(30) Foreign Application Priority Data
Jan. 12, 2022 (JP) 2022-002884

(51) Int. Cl. H01Q 5/10; H01Q 1/24; H01Q 1/48; H01Q 5/25; H01Q 9/04; H01Q 21/30

(52) U.S. Cl. CPC H01Q 5/10; H01Q 1/243; H01Q 1/48; H01Q 9/0421; H01Q 9/045; H01Q 21/30; H01Q 5/25

(57) ABSTRACT

An antenna device includes a first patch antenna, a second patch antenna, and a short circuit plate. The second patch antenna has a resonance frequency different from that of the first patch antenna. The short circuit plate short-circuits one side of the first patch antenna and one side of the second patch antenna to the ground. The length of one side of the short circuit plate, the one side being connected to the one side of the first patch antenna and the one side of the second patch antenna, is shorter than the length of each of the one side of the first patch antenna and the one side of the second patch antenna.

### FIELD

The present disclosure relates to an antenna device, an antenna module, and a radio device.

### BACKGROUND

These days, communication devices equipped with UWB (ultra wide band) radio systems are becoming widespread. The UWB radio system is mainly used for short-distance high-speed communication and position detection.

A patch antenna is known as an antenna adapted to a wide communication band like in a UWB radio system. For example, there is known a patch antenna in which multi-resonance is achieved by a scheme in which high-frequency signals of different operating bands are supplied to a planar antenna element in which patch elements having the operating bands are integrated (see Patent Literature 1).

### CITATION LIST

### Patent Literature

Patent Literature 1: JP 2021-97328 A

### SUMMARY

### Technical Problem

However, in the above-described technology, since patch elements having different operating frequency bands are integrated in order to achieve multi-resonance, the antenna itself may be increased in size. In the case where a UWB radio system is mounted on a terminal device such as a smartphone, not only bandwidth increase but also downsizing is required of the corresponding antenna. Thus, the present disclosure provides an antenna device, an antenna module, and a radio device that can be further downsized.

The above problem or object is merely one of a plurality of problems or objects that can be solved or achieved by the plurality of embodiments disclosed in the present specification.

### Solution to Problem

An antenna device of the present disclosure includes a first patch antenna, a second patch antenna, and a short circuit plate. The second patch antenna has a resonance frequency different from that of the first patch antenna. The short circuit plate short-circuits one side of the first patch antenna and one side of the second patch antenna to the ground. The length of one side of the short circuit plate, the one side being connected to the one side of the first patch antenna and the one side of the second patch antenna, is shorter than the length of each of the one side of the first patch antenna and the one side of the second patch antenna.

### BRIEF DESCRIPTION OF DRAWINGS

FIG. 1 is a diagram illustrating an example of a schematic configuration of an antenna device according to a first embodiment of the present disclosure.

FIG. 2 is a diagram illustrating an example of a schematic configuration of an antenna device.

FIG. 3 is a diagram for describing an operation example of the antenna device according to the first embodiment of the present disclosure.

FIG. 4 is a diagram illustrating an example of a schematic configuration of an antenna device according to a first modification example of the first embodiment of the present disclosure.

FIG. 5 is a diagram illustrating an example of a schematic configuration of an antenna device.

FIG. 6 is a diagram illustrating an example of power supply by striplines.

FIG. 7 is a diagram illustrating an example of power supply by a microstripline according to the first modification example of the first embodiment of the present disclosure.

FIG. 8 is a diagram illustrating an example of a schematic configuration of an antenna device according to a second modification example of the first embodiment of the present disclosure.

FIG. 9 is a diagram illustrating an example of a schematic configuration of an antenna device according to a second embodiment of the present disclosure.

FIG. 10 is a diagram illustrating an example of a schematic configuration of an antenna device according to a third modification example of the second embodiment of the present disclosure.

FIG. 11 is a side view of the antenna device according to the third modification example of the second embodiment of the present disclosure.

FIG. 12 is a diagram illustrating an example of a schematic configuration of an antenna device according to a third embodiment of the present disclosure.

FIG. 13 is a diagram illustrating an example of a schematic configuration of an antenna device according to a fourth embodiment of the present disclosure.

FIG. 14 is a diagram illustrating an example of a schematic configuration of an antenna device according to a fifth embodiment of the present disclosure.

FIG. 15 is a diagram illustrating an example of a schematic configuration of an antenna module according to a sixth embodiment of the present disclosure.

FIG. 16 is a diagram illustrating an arrangement example of the antenna module according to the sixth embodiment of the present disclosure.

FIG. 17 is a block diagram illustrating an example of a schematic configuration of a radio device according to a seventh embodiment of the present disclosure.

### DESCRIPTION OF EMBODIMENTS

Hereinbelow, embodiments of the present disclosure are described in detail with reference to the appended drawings. In the present specification and the drawings, substantially the same elements are denoted by the same reference numerals, and a repeated description is omitted.

Further, in the present specification and the drawings, specific values may be indicated and described, but the values are merely examples, and other values may be used.

One or a plurality of embodiments (including implementation examples and modification examples) described below can each be independently implemented. On the other hand, at least part of each of the plurality of embodiments described below may be implemented in combination with at least part of another embodiment, as appropriate. The plurality of embodiments can include novel features different from each other. Therefore, the plurality of embodiments can contribute to the solution of objects or problems different from each other, and can exhibit effects different from each other.

### 1. First Embodiment

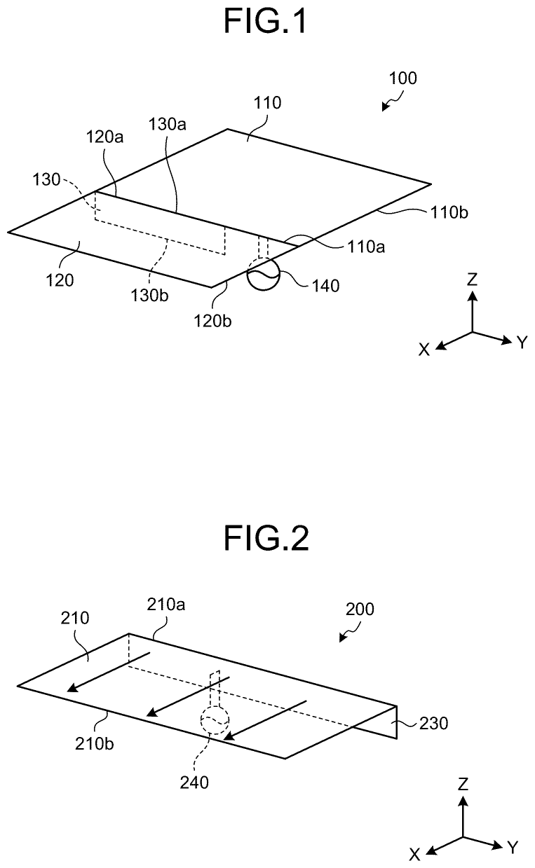

FIG. 1 is a diagram illustrating an example of a schematic configuration of an antenna device 100 according to a first embodiment of the present disclosure. Hereinafter, XYZ coordinates are illustrated in the drawings. The X-axis direction and the Y-axis direction correspond to planar directions of the antenna device 100. The Z-axis direction corresponds to the thickness direction of the antenna device 100.

The antenna device 100 illustrated in FIG. 1 includes a first patch antenna 110, a second patch antenna 120, a short circuit plate 130, and a feeding point 140.

The first patch antenna 110 is formed of, for example, a substantially quadrangular conductor plate. The first patch antenna 110 is, for example, an antenna element that resonates (operates) at a first resonance frequency. The first patch antenna 110 has a first side 110a and a second side 110b substantially orthogonal to the first side 110a. The second side 110b has, for example, a length according to the first resonance frequency.

The second patch antenna 120 is formed of, for example, a substantially quadrangular conductor plate. The second patch antenna 120 is, for example, an antenna element that resonates (operates) at a second resonance frequency different from the first resonance frequency. The second patch antenna 120 has a first side 120a and a second side 120b substantially orthogonal to the first side 120a. The second side 120b has, for example, a length according to the second resonance frequency.

As illustrated in FIG. 1, the first patch antenna 110 is, at the first side 110a, in contact with the first side 120a of the second patch antenna 120. The first side 110a of the first patch antenna 110 and the first side 120a of the second patch antenna 120 have the same length.

The second side 110b of the first patch antenna 110 and the second side 120b of the second patch antenna 120 have different lengths. Thereby, the first patch antenna 110 and the second patch antenna 120 resonate at different resonance frequencies.

A first side 130a of the short circuit plate 130 is in contact with the first side 110a of the first patch antenna 110 and the first side 120a of the second patch antenna 120. A second side 130b facing the first side 130a of the short circuit plate 130 is connected (short-circuited) to the ground (illustration omitted).

The short circuit plate 130 short-circuits the first side 110a of the first patch antenna 110, and short-circuits the first side 120a of the second patch antenna 120. That is, in the antenna device 100, the first patch antenna 110 and the second patch antenna 120 share the short circuit plate 130.

Thereby, as compared to the case where the short circuit plate 130 is provided for each of the first patch antenna 110 and the second patch antenna 120, the number of components of the antenna device 100 can be reduced, and the antenna device 100 can be downsized.

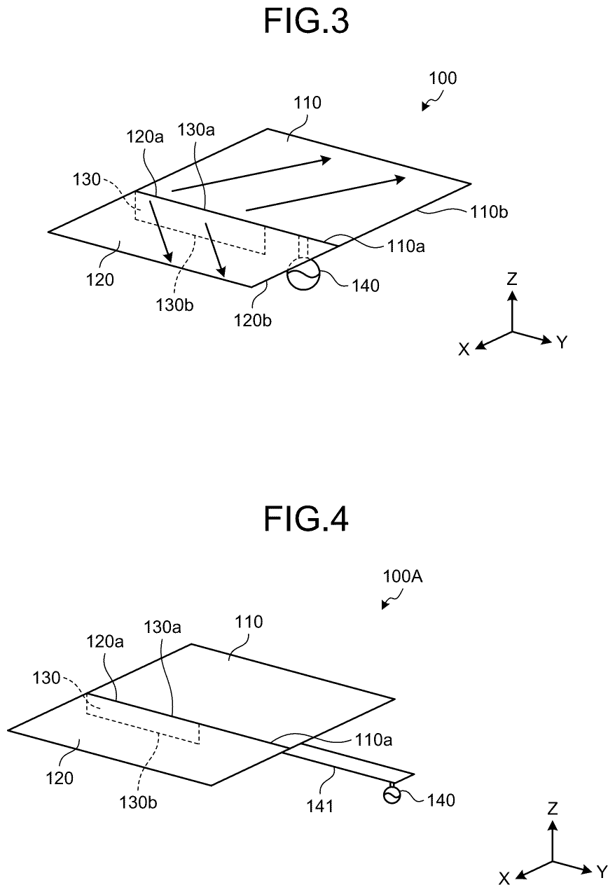

Here, the length of the first side 130a of the short circuit plate 130 is shorter than the length of each of the first side 110a of the first patch antenna 110 and the first side 120a of the second patch antenna 120. Thereby, the antenna device 100 according to the first embodiment of the present disclosure can downsize the first patch antenna 110 and the second patch antenna 120. This point will now be described using FIGS. 2 and 3.

FIG. 2 is a diagram illustrating an example of a schematic configuration of an antenna device 200. The antenna device 200 of FIG. 2 includes a patch antenna 210, a short circuit plate 230, and a feeding point 240.

The patch antenna 210 has a first side 210a and a second side 210b, and is in contact with the short circuit plate 230 at the first side 210a. One side of the short circuit plate 230 is in contact with the first side 210a of the patch antenna 210, and another side is connected to the ground (illustration omitted). The feeding point 240 is connected to a flat surface of the patch antenna 210, and supplies power to the patch antenna 210. By power being supplied by the feeding point 240, a current flows mainly in the X-axis direction of the patch antenna 210, and radio waves are radiated from the patch antenna 210.

As illustrated in FIG. 2, in the antenna device 200, one end (the first side 210a) of the patch antenna 210 is short-circuited to the ground (illustration omitted) via the short circuit plate 230. Thereby, the size of the patch antenna 210 (the length of the second side 210b) can be reduced to substantially half the size in the case where the short circuit plate 230 is not provided.

In general, the size of the patch antenna 210 not provided with the short circuit plate 230 is about half the wavelength of the resonance frequency (½λ). On the other hand, in the antenna device 200 of FIG. 2, by short-circuiting one end (the first side 210a) of the patch antenna 210 by means of the short circuit plate 230, the size of the patch antenna 210 can be reduced to about ¼ of the wavelength of the resonance frequency (¼λ).

FIG. 3 is a diagram for describing an operation

example of the antenna device 100 according to the first embodiment of the present disclosure. As described above, in the antenna device 100 according to the first embodiment of the present disclosure, the length of the short circuit plate 130 is shorter than the length of each of the first and second patch antennas 110 and 120.

Therefore, when power is supplied to the first and second patch antennas 110 and 120, currents each having a wavelength of about ¼ of the wavelength of the respective resonance frequency flow through the first and second patch antennas 110 and 120 obliquely with respect to the X-axis direction.

That is, in the first patch antenna 110 according to the first embodiment of the present disclosure, a current flows from the short circuit plate 130 toward the second side 110b, that is, obliquely with respect to the second side 110b. Therefore, the length of the second side 110b is shorter than about ¼ of the wavelength of the first resonance frequency.

Further, in the second patch antenna 120, a current flows from the short circuit plate 130 toward the second side 120b, that is, obliquely with respect to the second side 120b. Therefore, the length of the second side 120b is shorter than about ¼ of the wavelength of the second resonance frequency.

Thus, by setting the length of the first side 130a of the short circuit plate 130 to a length shorter than the length of each of the first sides 110a and 120a of the first and second patch antennas 110 and 120, the sizes (the lengths of the second sides 110b and 120b) of the first and second patch antennas 110 and 120 can be reduced.

Returning to FIG. 1, the feeding point 140 is placed to be connected to the first side 110a of the first patch antenna 110 and the first side 120a of the second patch antenna 120. That is, in the antenna device 100, power is supplied to the first side 110a of the first patch antenna 110 and the first side 120a of the second patch antenna 120 via the feeding point 140.

Thus, in the antenna device 100 according to the first embodiment of the present disclosure, power is supplied to each of the first and second patch antennas 110 and 120 by one feeding point 140. Thereby, the matching loss in the feeding line can be reduced. Details of this point will be described in a first modification example.

As above, the antenna device 100 according to the first embodiment of the present disclosure includes the first patch antenna 110, the second patch antenna 120 having a resonance frequency different from that of the first patch antenna 110, and the short circuit plate 130.

The short circuit plate 130 short-circuits the first side 110a of the first patch antenna 110 and the first side 120a of the second patch antenna 120 to the ground (a base plate). The length of one side (the first side 130a) of the short circuit plate 130, the one side of the short circuit plate 130 being connected to the first sides 110a and 120a of the first and second patch antennas 110 and 120, is shorter than the length of each of the first sides 110a and 120a of the first and second patch antennas 110 and 120.

Thereby, the antenna device 100 can reduce the sizes of the first and second patch antennas 110 and 120, and the antenna device 100 can be downsized.

### 2. First Modification Example

FIG. 4 is a diagram illustrating an example of a schematic configuration of an antenna device 100A according to a first modification example of the first embodiment of the present disclosure. The antenna device 100A illustrated in FIG. 4 is different from the antenna device 100 illustrated in FIG. 1 in that power is supplied to the first and second patch antennas 110 and 120 via a microstripline 141.

As illustrated in FIG. 4, the antenna device 100A includes a microstripline 141 of which one end is connected to one ends of one sides 110a and 120a of the first and second patch antennas 110 and 120. More specifically, one end of the microstripline 141 is connected to a corner formed by the first side 110a and the second side 110b of the first patch antenna 110 and a corner formed by the first side 120a and the second side 120b of the second patch antenna 120. Another end of the microstripline 141 is connected to the feeding point 140.

Thus, the antenna device 100A can be supplied with power by using the microstripline 141.

Here, as described above, in the antenna device 100A according to the present modification example, power is supplied to each of the first and second patch antennas 110 and 120 by using one feeding point 140. Therefore, power can be supplied to the first and second patch antennas 110 and 120 by one microstripline 141.

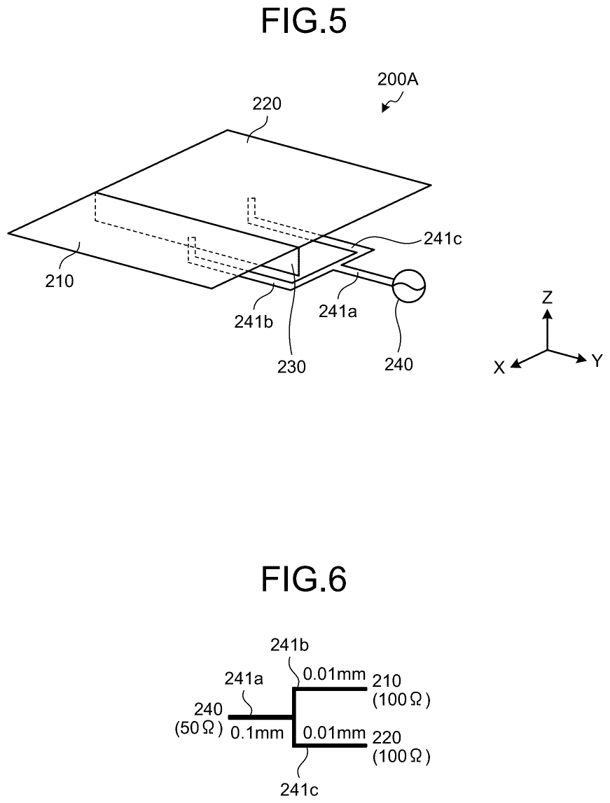

Therefore, the antenna device 100A according to the present modification example does not need to, for example, branch the feeding line into two like the antenna element disclosed in Patent Literature 1 described above, and can reduce the matching loss due to branching of the feeding line. This point will now be described using FIGS. 5 to 7.

FIG. 5 is a diagram illustrating an example of a schematic configuration of an antenna device 200A. The antenna device 200A of FIG. 5 includes a first patch antenna 210, a second patch antenna 220, a short circuit plate 230, a feeding point 240, and striplines 241a to 241c.

In the antenna device 200A, the length of a first side 130a of the short circuit plate 230 is the same as the length of each of a first side 210a of the first patch antenna 210 and a first side 220a of the second patch antenna 220. In this respect, the antenna device 200A is different from the antenna device 100A illustrated in FIG. 4.

Thus, in the antenna device 200A, the first patch antenna 210 and the second patch antenna 220 are divided by the short circuit plate 230. Hence, in the antenna device 200A, the striplines 241a to 241c are provided as feeders that connect each of the first patch antenna 210 and the second patch antenna 220 and the feeding point 240.

FIG. 6 is a diagram illustrating an example of power supply by the striplines 241a to 241c. As illustrated in FIG. 6, in the antenna device 200A, the stripline 241a branches into the striplines 241b and 241c, and thereby supplies power to each of the first patch antenna 210 and the second patch antenna 220.

Here, assuming that the impedance of the stripline 241a is 50 Ω, it is desirable that the impedance of each of the striplines 241b and 241c be set to 100 Ω in order to match the stripline 241a. This is because branched lines (the striplines 241b and 241c) can be regarded as being connected in parallel.

However, it is difficult to form striplines such that the stripline 241a and the striplines 241b and 241c match. In particular, in the case where the antenna device 200A is mounted on a housing (illustration omitted) like that of a smartphone and is used as a UWB antenna, the antenna device 200A is formed with a thickness of about 0.3 mm, and operates at a resonance frequency of 6 to 10 GHz.

In the case where the antenna device 200A is used as a UWB antenna for mounting on a housing, the antenna device 200A can be fabricated with a flexible printed circuit board (a flexible printed circuit, hereinafter also referred to as an “FPC”). In this case, the antenna device 200A is, for example, formed with a thickness of about 0.2 to 0.3 mm by using a dielectric having a permittivity of 2.9. Thus, in the antenna device 200A formed, a stripline 241a that makes matching in agreement with a high frequency band of UWB of 6 GHz to 10 GHz needs to be formed with a line width of about 0.1 mm. Further, each of the striplines 241b and 241c of 100 Ω needs to be formed with a line width of about 0.01 mm.

However, in the current technology, it is difficult to form striplines 241b and 241c each having a line width of 0.01 mm.

Thus, it is assumed that each of the striplines 241b and 241c is formed with a line width of 0.1 mm similarly to the stripline 241a. Then, the matching loss at the connection point with the striplines 241b and 241c becomes large, for example, 1 dB.

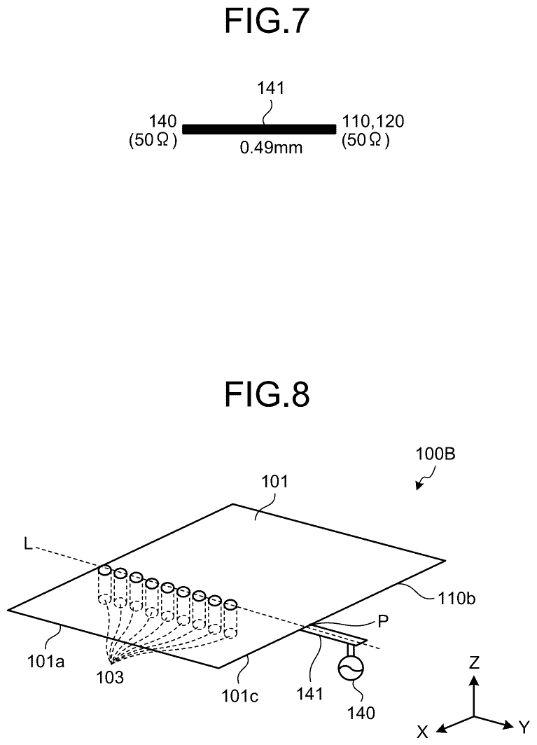

FIG. 7 is a diagram illustrating an example of power supply by the microstripline 141 according to the first modification example of the first embodiment of the present disclosure. As illustrated in FIG. 7, in the antenna device 100A according to the present modification example, power is supplied to both the first and second patch antennas 110 and 120 by one microstripline 141.

Thus, by supplying power to both the first and second patch antennas 110 and 120 by means of one microstripline 141, the antenna device 100A does not need to branch the microstripline 141. That is, in the antenna device 100A, it is sufficient that one microstripline 141 having an impedance of 50 Ω be formed.

As described above, in the case where the antenna device 100A is used as a UWB antenna for mounting on a housing, the antenna device 100A can be fabricated with an FPC. In this case, it is assumed that the antenna device 100A is, for example, formed with a thickness of about 0.2 by using a dielectric having a permittivity of 2.9 and that the microstripline 141 is formed to match 50 Ω at an operating frequency of 7 GHz. In this case, the line width of the microstripline 141 is about 0.49 mm.

Thus, the antenna device 100A according to the present modification example does not need to branch the microstripline 141, and can reduce the matching loss due to branching. Further, since the antenna device 100A does not need branching of the microstripline 141, the design of the feeding line is easier. Thereby, the antenna device 100A can more easily achieve downsizing and reduction in matching loss while keeping the performance of the antenna.

### 3. Second Modification Example

Although the first and second patch antennas 110 and 120 are configured as different antenna elements in the first embodiment and the first modification example, the present disclosure is not limited thereto. For example, the first and second patch antennas 110 and 120 may be an integrally formed element. That is, the first and second patch antennas 110 and 120 may be formed using one conductor plate.

Further, although in FIG. 1 the short circuit plate 130 is formed of one conductor plate, the present disclosure is not limited thereto. For example, the short circuit plate 130 may be formed of a plurality of vias. In this case, the short circuit plate 130 has a configuration in which a plurality of vias that connect the first and second patch antennas 110 and 120 and the ground (illustration omitted) are provided along the first side 130a.

FIG. 8 is a diagram illustrating an example of a schematic configuration of an antenna device 100B according to a second modification example of the first embodiment of the present disclosure.

In the case where, for example, the first and second patch antennas 110 and 120 are formed of one conductor plate 101, the antenna device 100 includes one conductor plate 101 and a plurality of vias 103 formed in the conductor plate 101 substantially parallel to a first side 101a of the conductor plate 101.

The plurality of vias 103 are arranged substantially in a straight line in the direction from a second side 101b substantially perpendicular to the first side 101a to a third side 101c parallel to the second side 101b. The plurality of vias 103 are arranged substantially in a straight line from the second side 101b not to the third side 101c but to a substantially central region of the conductor plate 101 before reaching the third side 101c.

The feeding point 140 is connected to the third side 101c via a microstripline 141. In the example of FIG. 8, the microstripline 141 is connected to the conductor plate 101 at the intersection point P of a straight line L in which the plurality of vias 103 are aligned and the third side 101c.

In FIG. 8, the plurality of vias 103 are arranged nearer to the first side 101a with respect to the center of the conductor plate 101. In what positions of the conductor plate 101 the plurality of vias 103 are to be formed is determined according to the size or the resonance frequencies (the first and second resonance frequencies) of the conductor plate 101.

Thus, the antenna device 100B may be configured with one conductor plate 101 and a plurality of vias 103.

### 4. Second Embodiment

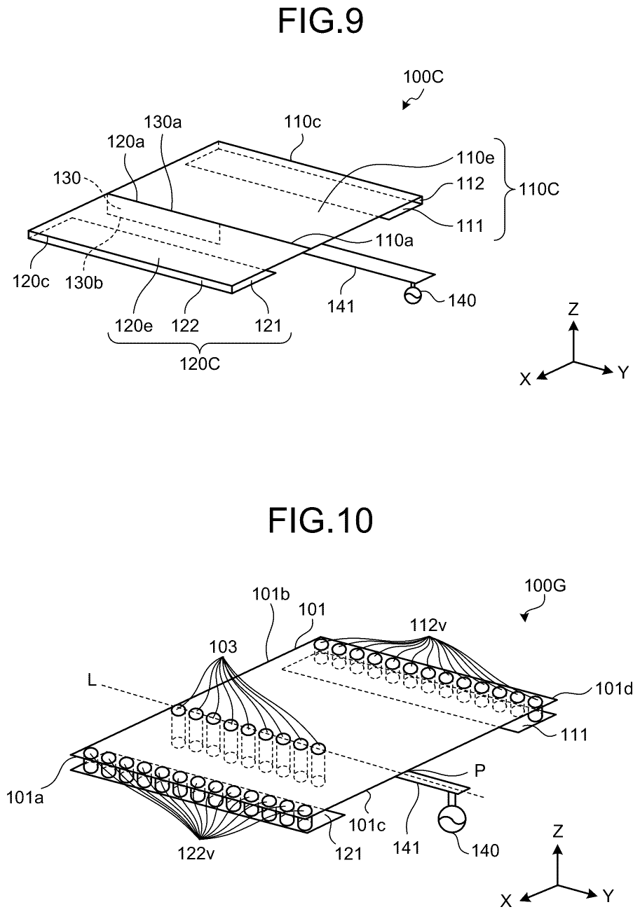

FIG. 9 is a diagram illustrating an example of a schematic configuration of an antenna device 100C according to a second embodiment of the present disclosure. The antenna device 100C of FIG. 9 is different from the antenna device 100A of FIG. 4 in that end portions of a first and a second patch antennas 110C and 120C are folded back.

As illustrated in FIG. 9, the first patch antenna 110C includes a first conductor plate 110e, a second conductor plate 111, and a third conductor plate 112. The first conductor plate 110e operates as a main radiation surface of the first patch antenna 110C. The second conductor plate 111 is placed substantially parallel to the first conductor plate 110e. The second conductor plate 111 is placed between the ground (illustration omitted) and the first conductor plate 110e.

The third conductor plate 112 is placed substantially perpendicular to the first conductor plate 110e and the second conductor plate 111. One side of the third conductor plate 112 is connected to a third side 110c of the first conductor plate 110e, and another side is connected to one side of the second conductor plate 111.

The third conductor plate 112 electrically connects the first conductor plate 110e and the second conductor plate 111.

Thus, the first patch antenna 110C has a folded portion (folded structure) including the second conductor plate 111 and the third conductor plate 112.

The second patch antenna 120C includes a first conductor plate 120e, a second conductor plate 121, and a third conductor plate 122. The first conductor plate 120e operates as a main radiation surface of the second patch antenna 120C. The second conductor plate 121 is placed substantially parallel to the first conductor plate 120e. The second conductor plate 121 is placed between the ground (illustration omitted) and the first conductor plate 120e.

The third conductor plate 122 is placed substantially perpendicular to the first conductor plate 120e and the second conductor plate 121. One side of the third conductor plate 122 is connected to a third side 120c of the first conductor plate 120e, and another side is connected to one side of the second conductor plate 121. The third conductor plate 122 electrically connects the first conductor plate 120e and the second conductor plate 121.

Thus, the second patch antenna 120C has a folded portion (folded structure) including the second conductor plate 121 and the third conductor plate 122.

As above, the antenna device 100C according to the second embodiment of the present disclosure has a folded structure on each of the third sides 110c and 120c (examples of another side) of the first and second patch antennas 110 and 120. Thereby, the antenna device 100C can achieve further downsizing in the area of exclusive use in the XY plane.

### 5. Third Modification Example

Although in the second embodiment the first and second patch antennas 110 and 120 are configured as different antenna elements, the present disclosure is not limited thereto. For example, the first and second patch antennas 110 and 120 may be an integrally formed element. That is, the first and second patch antennas 110 and 120 may be formed using one conductor plate.

Further, although in the second embodiment the short circuit plate 130 and the third conductor plates 112 and 122 are each formed of one conductor plate, the present disclosure is not limited thereto. For example, the short circuit plate 130 may be formed of a plurality of vias. In this case, the short circuit plate 130 has a configuration in which a plurality of vias that connect the first and second patch antennas 110 and 120 and the ground (illustration omitted) are provided along the first side 130a. Further, the third conductor plates 112 and 122 have configurations in which pluralities of vias that connect the first and second patch antennas 110 and 120 and the second conductor plates 111 and 112 are provided along the third sides 110c and 120c, respectively.

That is, while in the second embodiment an example in which the antenna device 100A illustrated in FIG. 4 has a folded structure is described, the antenna device 100B illustrated in FIG. 8 may have a folded structure.

FIG. 10 is a diagram illustrating an example of a

schematic configuration of an antenna device 100G according to a third modification example of the second embodiment of the present disclosure. The antenna device 100G illustrated in FIG. 10 includes, in addition to the configuration of the antenna device 100B illustrated in FIG. 8, a plurality of first vias 112v, a plurality of second vias 122v, and second conductor plates 111 and 121. The configurations of the second conductor plates 111 and 121 are the same as those of the second conductor plates 111 and 121 of the antenna device 100B illustrated in FIG. 9.

The plurality of first vias 112v are arranged substantially in a straight line along a fourth side 101d facing the second side 101a. The first via 112v electrically connects the fourth side 101d of the conductor plate 101 and the second conductor plate 111.

The plurality of second vias 122v are arranged substantially in a straight line along the second side 101a. The second via 122v electrically connects the second side 101a of the conductor plate 101 and the second conductor plate 121.

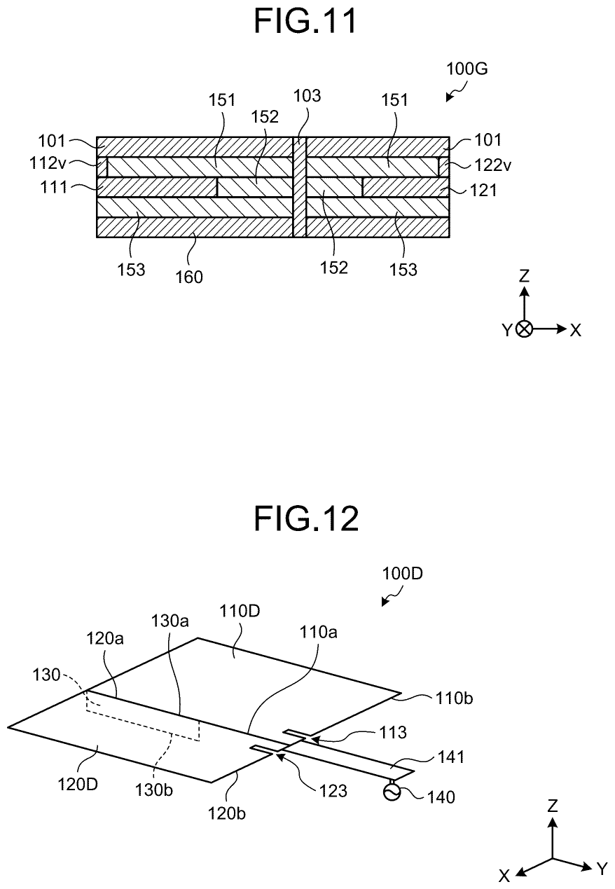

FIG. 11 is a side view of the antenna device 100G according to the third modification example of the second embodiment of the present disclosure. FIG. 11 illustrates a case where the antenna device 100G is configured with an FPC. FIG. 11 illustrates a side view of the antenna device 100G of FIG. 10 as viewed from the negative side of the Y axis.

As illustrated in FIG. 11, the FPC is formed of five layers. The first conductor plate 101 is formed. In the third layer, the second conductor plates 111 and 121 and a dielectric layer 152 are formed.

In the second layer, the first via 112v, the second via 122v, and a dielectric layer 151 are formed. The antenna device 100G has a plurality of first vias 112v that penetrate the second layer and electrically connect the first conductor plate 101 and the second conductor plate 111. The antenna device 100G has a plurality of second vias 122v that penetrate the second layer and electrically connect the first conductor plate 101 and the second conductor plate 121.

In the fourth layer, a dielectric layer 153 is formed. In the fifth layer, a conductor plate 160 functioning as the ground is formed.

The antenna device 100G has a plurality of vias 103 that electrically connect the first conductor plate 101 and the conductor plate 160. The antenna device 100G has a plurality of vias 103 that electrically connect the first conductor plate 101 and the conductor plate 160.

Although illustration is omitted in FIG. 11, a microstripline 141 that supplies power to the first conductor plate 101 is formed in the first layer.

The permittivities of the dielectric layers 151 to 153 formed in the second to fourth layers may be the same or different from each other. The dielectric layer may play a role as adhesive paper.

Thus, the antenna device 100G can be produced as an FPC. By thus using an FPC to create a folded structure, for example, the first conductor plate 101 and each of the second conductor plates 111 and 121 can be arranged with a gap of, for example, about 0.1 mm. Thus, by using an FPC and vias to configure an antenna device 100G, a thin antenna device of about 0.3 mm can be produced.

### 6. Third Embodiment

FIG. 12 is a diagram illustrating an example of a schematic configuration of an antenna device 100D according to a third embodiment of the present disclosure. The antenna device 100D of FIG. 12 is different from the antenna device 100A of FIG. 4 in that each of the second sides 110b and 120b of a first and a second patch antenna 110D and 120D has a notch (slit).

As illustrated in FIG. 12, the second side 110b of the first patch antenna 110D has a notch 113 in the vicinity of the joining portion with the microstripline 141. Further, the second side 120b of the second patch antenna 120D has a notch 123 in the vicinity of the joining portion with the microstripline 141.

Thus, the antenna device 100D performs inset power supply by providing the notches 113 and 123 in the joining portions between the microstripline 141 and the first and second patch antennas 110D and 120D. Thereby, the antenna device 100D can more easily make matching with each of the first resonance frequency and the second resonance frequency.

Although herein the antenna device 100D has notches 113 and 123 on both the second sides 110b and 120b of the first and second patch antennas 110D and 120D, the present disclosure is not limited thereto. The antenna device 100D may have a notch 113 (or a notch 123) on at least one of the second sides 110b and 120b.

### 7. Fourth Embodiment

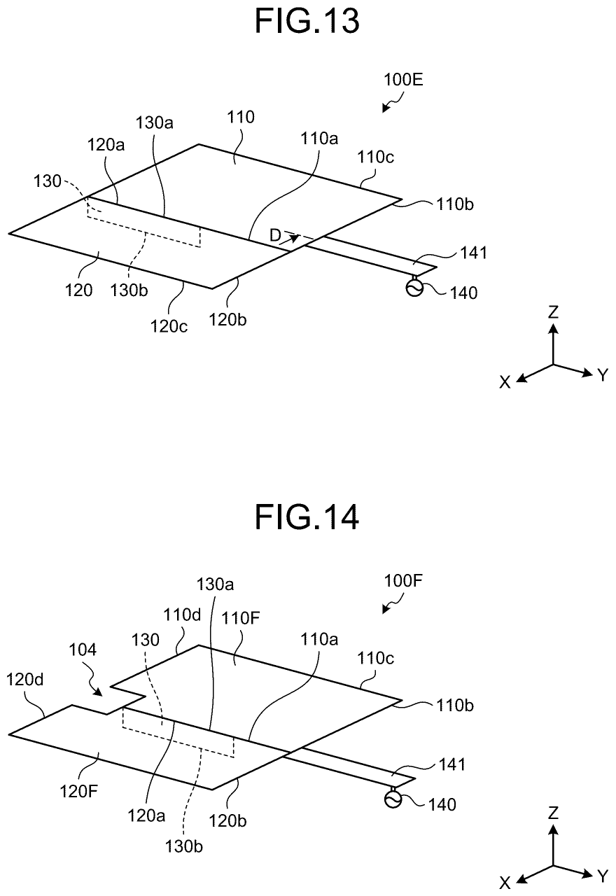

FIG. 13 is a diagram illustrating an example of a schematic configuration of an antenna device 100E according to a fourth embodiment of the present disclosure. The antenna device 100E of FIG. 13 is different from the antenna device 100A of FIG. 4 in the joining position between the microstripline 141 and the first and second patch antennas 110 and 120.

The microstripline 141 of the antenna device 100E illustrated in FIG. 13 is placed such that one end of the microstripline 141 is connected to the second side 110b of the first patch antenna 110. Thus, the microstripline 141 of the fourth embodiment is connected to the second side 110b with a shift of distance D from the first side 110a of the first patch antenna 110 toward the third side 110c.

In the antenna device 100A illustrated in FIG. 4, the microstripline 141 is placed on an extension line in the longitudinal direction of the short circuit plate 130. On the other hand, in the antenna device 100E illustrated in FIG. 13, the microstripline 141 is placed with a shift (parallel translation) of distance D in a direction substantially perpendicular to the longitudinal direction of the short circuit plate 130.

Thus, by supplying power to the first and second patch antennas 110 and 120 with a shift from end portions of the first and second patch antennas 110 and 120, the antenna device 100E can adjust radiation efficiency between the first and second resonance frequencies.

Although in FIG. 13 the microstripline 141 is connected to the second side 110b of the first patch antenna 110, the present disclosure is not limited thereto. The microstripline 141 may be connected to the second side 120b of the second patch antenna 120. That is, the microstripline 141 may be connected to a position of the second side 120b of the second patch antenna 120 away from the first side 120a toward the third side 120c by distance D.

Thus, the feeder (the microstripline 141) that supplies power to the first and second patch antennas 110 and 120 can be placed with a shift toward either of the first patch antenna 110 and the second patch antenna 120.

### 8. Fifth Embodiment

FIG. 14 is a diagram illustrating an example of a schematic configuration of an antenna device 100F according to a fifth embodiment of the present disclosure. The antenna device 100F of FIG. 14 is different from the antenna device 100A of FIG. 4 in that a slit (notch) 104 is provided on fourth sides 110d and 120d of a first and a second patch antenna 110F and 120F.

As illustrated in FIG. 14, the antenna device 100F has a slit 104 on the fourth sides 110d and 120d of the first and second patch antennas 110F and 120F. Accordingly, the short circuit plate 130 is placed with a shift toward the microstripline 141 with respect to that of the antenna device 100A illustrated in FIG. 4.

In the antenna device 100F of the fifth embodiment, the short circuit plate 130 is shifted toward the second sides 110b and 120b of the first and second patch antennas 110F and 120F. Thereby, portions of the first sides 110a and 120a not short-circuited by the short circuit plate 130 are generated on the sides of the fourth sides 110d and 120d. A slit 104 that notches the first sides 110a and 120a is formed in the generated portions.

Thus, by providing the slit 104, the length in the resonance length direction (the X-axis direction) of the antenna device 100F can be reduced. Therefore, the antenna device 100F according to the fifth embodiment can achieve further downsizing.

### 9. Sixth Embodiment

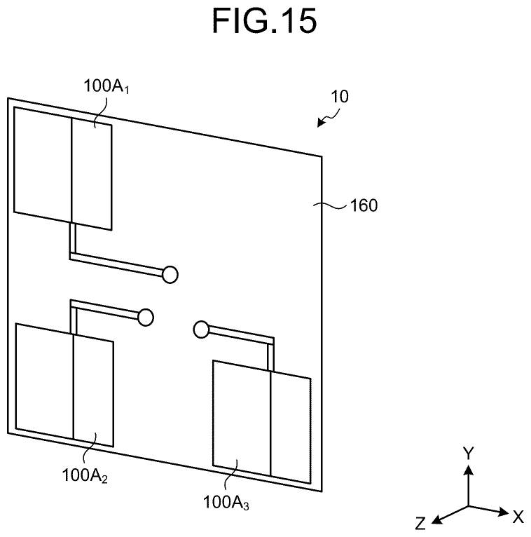

FIG. 15 is a diagram illustrating an example of a schematic configuration of an antenna module 10 according to a sixth embodiment of the present disclosure. The antenna module 10 illustrated in FIG. 15 includes a ground 160 and a first to a third antenna device 100A₁ to 100A₃.

In the example illustrated in FIG. 15, the first to third antenna devices 100A₁ to 100A₃ are arranged in a substantially L-shaped configuration. That is, the first and second antenna devices 100A₁ and 100A₂ are arranged side by side in the Y-axis direction, and the second and third antenna devices 100A₂ and 100A₃ are arranged side by side in the X-axis direction.

In the example illustrated in FIG. 15, the first to third antenna devices 100A₁ to 100A₃ are arranged such that the polarization directions thereof are the same. That is, the first to third antenna devices 100A₁ to 100A₃ are arranged such that the longitudinal directions of the short circuit plates thereof run along the same direction (the Y-axis direction).

As described above, in the antenna module 10, the first and second antenna devices 100A₁ and 100A₂ are arranged side by side in the Y-axis direction. Therefore, a detection device (illustration omitted) connected to the antenna module 10 can detect the elevation angle (elevation direction) of a reception signal by using the phase difference between signals received by the first and second antenna devices 100A₁ and 100A₂.

Further, in the antenna module 10, the second and third antenna devices 100A₂ and 100A₃ are arranged side by side in the X-axis direction. Therefore, a detection device (illustration omitted) connected to the antenna module 10 can detect the azimuth angle (azimuth direction) of a reception signal by using the phase difference between signals received by the second and third antenna devices 100A₂ and 100A₃.

The above-described detection device (illustration omitted) estimates the elevation angle and the azimuth angle of a reception signal described above by using the first to third antenna devices 100A₁ to 100A₃. Further, the detection device (illustration omitted) performs distance measurement of a reception signal (that is, detection of the distance to a transmission device that has transmitted a reception signal) by using any one of the first to third antenna devices 100A₁ to 100A₃. Thus, the detection device (illustration omitted) enables distance measurement and position measurement of a reception signal by using the antenna module 10.

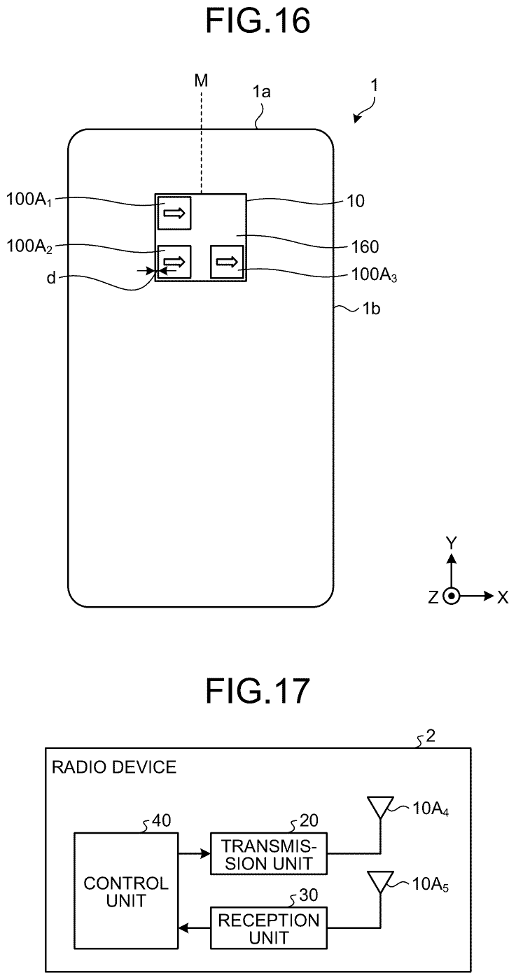

FIG. 16 is a diagram illustrating an arrangement example of the antenna module 10 according to the sixth embodiment of the present disclosure. FIG. 16 illustrates a case where the antenna module 10 is mounted on, for example, a terminal device 1 such as a smartphone. That is, FIG. 16 illustrates a case where the antenna module 10 is mounted on a substantially rectangular housing.

As illustrated in FIG. 16, in the case where the antenna module 10 is mounted on the housing of the terminal device 1, the antenna module 10 is placed such that the polarization directions of the first to third antenna devices 100A₁ to 100A₃ are substantially parallel to a short side 1a of the housing of the terminal device 1.

Further, the antenna module 10 is placed in the housing of the terminal device 1 to be located substantially at the center M in the short direction of the housing of the terminal device 1. Thereby, the housing of the terminal device 1 can be regarded as the ground of the antenna module 10. Thus, the ground 160 of the antenna module 10 can be made small.

In general, a patch antenna is provided with a ground larger than the antenna element in order to obtain an end effect. However, the size of the ground has been a factor in size increase of the antenna device (or the antenna module).

Thus, in the sixth embodiment of the present disclosure, the antenna module 10 is placed substantially at the center M in the short direction of the terminal device 1, and thereby the terminal device 1 can be regarded as the ground of the antenna module 10 as described above. Thereby, even when the ground 160 of the antenna module 10 is small, the first to third antenna devices 100A₁ to 100A₃ can obtain a sufficient end effect, and the antenna module 10 can obtain sufficient radiation efficiency while achieving downsizing.

For example, it is assumed that, as viewed from the Z-axis direction, the distance d between an end portion of the ground 160 and each of end portions of the first to third antenna devices 100A₁ to 100A₃ is 1 mm or less. Even in this case, the antenna module 10 can obtain sufficient radiation efficiency by placing the antenna module 10 substantially at the center in the polarization direction of the terminal device 1.

Although herein an example in which the antenna module 10 includes the antenna device 100A according to the first modification example of the first embodiment is described, the antenna device included in the antenna module 10 is not limited thereto. The antenna module 10 can include any of the antenna devices of the embodiments and the modification examples.

Further, although herein a case where the antenna module 10 includes three antenna devices 100A is described, the present disclosure is not limited thereto. The number of antenna devices 100A included in the antenna module 10 may be two or less, or four or more.

Further, the arrangement of the first to third antenna devices 100A₁ to 100A₃ is not limited to the example of FIG. 15. The first to third antenna devices 100A₁ to 100A₃ may, for example, be arranged in a row.

### 10. Seventh Embodiment

FIG. 17 is a block diagram illustrating an example of a schematic configuration of a radio device 2 according to a seventh embodiment of the present disclosure.

The radio device 2 illustrated in FIG. 17 includes a transmission-side antenna device 100A₄, a reception-side antenna device 100A₅, a transmission unit 20, a reception unit 30, and a control unit 40.

The transmission-side antenna device 100A₄ has, for example, the same configuration as the antenna device 100A illustrated in FIG. 4. The transmission-side antenna device 100A₄ transmits, to a communication partner (illustration omitted), a transmission signal generated by the transmission unit 20.

The reception-side antenna device 100A₅ has, for example, the same configuration as the antenna device 100A illustrated in FIG. 4. The reception-side antenna device 100A₅ outputs, to the reception unit 30, a reception signal received from a communication partner.

The transmission unit 20 generates a transmission signal in accordance with an instruction from the control unit 40, and outputs the transmission signal to the transmission-side antenna device 100A₄. The reception unit 30 decodes a reception signal in accordance with an instruction from the control unit 40. The control unit 40 controls the transmission unit 20 and the reception unit 30 to perform communication with a communication partner.

Thus, the radio device 2 according to the present embodiment includes the antenna device 100A and a radio unit (the transmission unit 20 and/or the reception unit 30). By virtue of the fact that the radio device 2 includes the antenna device 100A, which can achieve downsizing, the radio device 2 can be further downsized.

Although herein the radio device 2 includes antenna devices 100A as both a transmission-side antenna and a reception-side antenna, the present disclosure is not limited thereto. The radio device 2 may include an antenna device 100A as at least one of a transmission-side antenna and a reception-side antenna. Further, the radio device 2 may perform one of transmission and reception instead of both transmission and reception.

Although herein an example in which the radio device 2 includes the antenna device 100A according to the first modification example of the first embodiment is described, the antenna device included in the radio device 2 is not limited thereto. The radio device 2 can include any of the antenna devices of the embodiments and the modification examples.

Although herein the radio device 2 performs communication with a communication partner, the present disclosure is not limited thereto. For example, the radio device 2 may perform at least one of distance measurement and angle measurement for a radio device as a measurement target (illustration omitted). Here, in the case where the radio device 2 performs distance measurement and/or angle measurement on the basis of a transmission signal transmitted by a radio device as a measurement target, the transmission unit 20 of the radio device 2 can be omitted. Alternatively, in the case where a signal is transmitted to a measurement device (illustration omitted) that performs distance measurement and/or angle measurement of the radio device 2, the reception unit 30 of the radio device 2 can be omitted.

### 11. Summary

Hereinabove, embodiments of the present disclosure are described; however, the technical scope of the present disclosure is not limited to the embodiments described above as they are, and various alterations can be made without departing from the gist of the present disclosure. Further, components of different embodiments and modification examples may be combined as appropriate.

The effects in the embodiments described in the present specification are merely examples and are not limitative ones, and there may be other effects.

The present technology can also take the following configurations.

(1)
An antenna device comprising:
a first patch antenna;
a second patch antenna having a resonance frequency different from a resonance frequency of the first patch antenna; and
a short circuit plate that short-circuits one side of the first patch antenna and one side of the second patch antenna to a ground,
wherein a length of one side of the short circuit plate, the one side of the short circuit plate being connected to the one side of the first patch antenna and the one side of the second patch antenna, is shorter than a length of each of the one side of the first patch antenna and the one side of the second patch antenna.
   (2)

The antenna device according to (1), wherein the first patch antenna and the second patch antenna are supplied with power by one feeder.

(3)

The antenna device according to (2), wherein one end of the feeder is connected to one end of the one side of the first patch antenna and one end of the one side of the second patch antenna.

(4)

The antenna device according to (2) or (3), wherein one end of the feeder is connected to a position of a side of one of the first patch antenna and the second patch antenna, the position being away by a predetermined distance from one ends of the one sides of the first patch antenna and the second patch antenna.

(5)

The antenna device according to any one of (2) to (4), having a notch on at least one of a side connected to the feeder of the first patch antenna and a side connected to the feeder of the second patch antenna.

(6)

The antenna device according to any one of (1) to (5), wherein the short circuit plate is formed of a plurality of vias.

(7)

The antenna device according to any one of (1) to (6), wherein the one side of the first patch antenna and the one side of the second patch antenna are connected to each other.

(8)

The antenna device according to any one of (1) to (7), wherein the first patch antenna and the second patch antenna are formed using one conductor plate.

(9)

The antenna device according to any one of (1) to (8), wherein at least one of the first patch antenna and the second patch antenna has a folded structure on another side facing the one side.

(10)

The antenna device according to (9), wherein the folded structure includes:
a conductor plate substantially parallel to at least one of the first patch antenna and the second patch antenna; and
a plurality of vias that connect one side of the conductor plate and the other side of at least one of the first patch antenna and the second patch antenna.
   (11)

The antenna device according to any one of (1) to (10), having a notch on a side of at least one of the first patch antenna and the second patch antenna, the side being connected to one end of the short circuit plate.

(12)

An antenna module comprising a ground and an antenna device,
the antenna device including:
a first patch antenna;
a second patch antenna having a resonance frequency different from a resonance frequency of the first patch antenna; and
a short circuit plate that short-circuits one side of the first patch antenna and one side of the second patch antenna to the ground,
wherein a length of one side of the short circuit plate, the one side of the short circuit plate being connected to the one side of the first patch antenna and the one side of the second patch antenna, is shorter than a length of each of the one side of the first patch antenna and the one side of the second patch antenna.
   (13)

The antenna module according to (12), wherein the antenna device includes three antenna devices, and the three antenna devices are arranged in an L-shaped configuration on a surface of the ground.

(14)

The antenna module according to (12) or (13), wherein
the antenna module is mounted on a substantially rectangular housing, and
the ground is placed to be located substantially at a center in a short direction of the housing.
   (15)

A radio device comprising:
an antenna device; and
a radio unit that performs transmission or reception of a signal via the antenna device,
wherein the antenna device includes:
a first patch antenna;
a second patch antenna having a resonance frequency different from a resonance frequency of the first patch antenna; and
a short circuit plate that short-circuits one side of the first patch antenna and one side of the second patch antenna to a ground, and
a length of one side of the short circuit plate, the one side of the short circuit plate being connected to the one side of the first patch antenna and the one side of the second patch antenna, is shorter than a length of each of the one side of the first patch antenna and the one side of the second patch antenna.

### REFERENCE SIGNS LIST

1 TERMINAL DEVICE
2 RADIO DEVICE
10 ANTENNA MODULE
20 TRANSMISSION UNIT
30 RECEPTION UNIT
40 CONTROL UNIT
100, 100A, 100B, 100C, 100D, 100E, 100F ANTENNA DEVICE
101 CONDUCTOR PLATE
103 VIA
104 SLIT
110, 110C, 110D FIRST PATCH ANTENNA
120, 120C, 120D SECOND PATCH ANTENNA
110e, 120e FIRST CONDUCTOR PLATE
111, 121 SECOND CONDUCTOR PLATE
112, 122 THIRD CONDUCTOR PLATE
130 SHORT CIRCUIT PLATE
140 FEEDING POINT
141, 141a, 141b MICROSTRIPLINE
151, 152, 153 DIELECTRIC LAYER
160 GROUND

1. An antenna device comprising:
a first patch antenna;
a second patch antenna having a resonance frequency different from a resonance frequency of the first patch antenna; and
a short circuit plate that short-circuits one side of the first patch antenna and one side of the second patch antenna to a ground,
wherein a length of one side of the short circuit plate, the one side of the short circuit plate being connected to the one side of the first patch antenna and the one side of the second patch antenna, is shorter than a length of each of the one side of the first patch antenna and the one side of the second patch antenna.

2. The antenna device according to claim 1, wherein the first patch antenna and the second patch antenna are supplied with power by one feeder.

3. The antenna device according to claim 2, wherein one end of the feeder is connected to one end of the one side of the first patch antenna and one end of the one side of the second patch antenna.

4. The antenna device according to claim 2, wherein one end of the feeder is connected to a position of a side of one of the first patch antenna and the second patch antenna, the position being away by a predetermined distance from one ends of the one sides of the first patch antenna and the second patch antenna.

5. The antenna device according to claim 2, having a notch on at least one of a side connected to the feeder of the first patch antenna and a side connected to the feeder of the second patch antenna.

6. The antenna device according to claim 1, wherein the short circuit plate is formed of a plurality of vias.

7. The antenna device according to claim 1, wherein the one side of the first patch antenna and the one side of the second patch antenna are connected to each other.

8. The antenna device according to claim 1, wherein the first patch antenna and the second patch antenna are formed using one conductor plate.

9. The antenna device according to claim 1, wherein at least one of the first patch antenna and the second patch antenna has a folded structure on another side facing the one side.

10. The antenna device according to claim 9, wherein
the folded structure includes:
a conductor plate substantially parallel to at least one of the first patch antenna and the second patch antenna; and
a plurality of vias that connect one side of the conductor plate and the other side of at least one of the first patch antenna and the second patch antenna.

11. The antenna device according to claim 1, having a notch on a side of at least one of the first patch antenna and the second patch antenna, the side being connected to one end of the short circuit plate.

12. An antenna module comprising a ground and an antenna device,
the antenna device including:
a first patch antenna;
a second patch antenna having a resonance frequency different from a resonance frequency of the first patch antenna; and
a short circuit plate that short-circuits one side of the first patch antenna and one side of the second patch antenna to the ground,
wherein a length of one side of the short circuit plate, the one side of the short circuit plate being connected to the one side of the first patch antenna and the one side of the second patch antenna, is shorter than a length of each of the one side of the first patch antenna and the one side of the second patch antenna.

13. The antenna module according to claim 12, wherein the antenna device includes three antenna devices, and the three antenna devices are arranged in an L-shaped configuration on a surface of the ground.

14. The antenna module according to claim 12, wherein
the antenna module is mounted on a substantially rectangular housing, and
the ground is placed to be located substantially at a center in a short direction of the housing.

15. A radio device comprising:
an antenna device; and
a radio unit that performs transmission or reception of a signal via the antenna device,
wherein the antenna device includes:
a first patch antenna;
a second patch antenna having a resonance frequency different from a resonance frequency of the first patch antenna; and
a short circuit plate that short-circuits one side of the first patch antenna and one side of the second patch antenna to a ground, and
a length of one side of the short circuit plate, the one side of the short circuit plate being connected to the one side of the first patch antenna and the one side of the second patch antenna, is shorter than a length of each of the one side of the first patch antenna and the one side of the second patch antenna.
